(19) United States
(12) Patent Application Publication
(10) Pub. No.: US 2006/0243914 A1
(43) Pub. Date: Nov. 2, 2006

(54) Attenuation map generation from pet scans

(76) Inventor: Thomas Köhler, Norderstedt (DE)

Correspondence Address: PHILIPS INTELLECTUAL PROPERTY & STANDARDS, 595 MINER ROAD, CLEVELAND, OH, 44143, US

(21) Appl. No.: 10/553,840

(22) PCT Filed: Apr. 14, 2004
(86) PCT No.: PCT/IB04/50430

§ 371 Date: Jun. 27, 2006

(30) Foreign Application Priority Data
Apr. 22, 2003 (EP) 03101102.6

(51) Int. Cl. G06K 9/00

(52) U.S. Cl. 250/363.04; 382/131

(57) ABSTRACT

An important prerequisite for the reconstruction of the emission map in a PET scan is a proper reconstruction of the attenuation map. According to the present invention, transmission data acquired with a helical source trajectory are parallel rebinned. Then, the data are weighted with the cosine of the cone angle and ramp filtered row by row. The filtered data are back-projected by using the rebinned geometry. Advantageously, according to the present invention, all available data are taken into account, thus allowing for a high efficiency in terms of dose utilization. Furthermore, since the correct cone-beam geometry is taken into account, an improved image quality is achieved.

The present invention pertains to the field of medical imaging. More particularly, the present invention relates to attenuation map reconstruction in positron emission tomography (PET). In particular, the present invention relates to a method of reconstructing attenuation data from transmission data of a PET scan, to an image processing device for reconstructing attenuation data from transmission data obtained from a PET scanner, to a PET system and to a computer program product comprising computer program means.

In medical imaging techniques known as emission computed tomography, images of an object are created based on the detection of gamma rays emitted from the object. In positron emission tomography (PET), positron-electron annihilations within the object to be imaged cause gamma rays to be emitted in pairs of two gamma photons, which fly in exactly opposite directions. The path formed by each pair of gamma photons represents a line, which is sometimes referred to as a “line of coincidence”. The specific distribution of the positron emitting contrast agent within the object can be determined by calculating the positions of these lines of coincidence. The aggregate of such information can be used to construct an image.

Energy carried by the gamma photons is typically sensed by detectors disposed in an array about the subject under study. The detectors convert the energy carried by the gamma photons, to record the position of the event, which gave rise to the arrays. Electrical signals representative of the detected gamma photons may be processed by a system, which typically includes a programmed digital computer capable of processing the position data to form an image of the structure, organ, or patient under examination. It is the aim of PET-imaging to reconstruct the distribution of a contrast agent within the human body. This distribution is called emission image and it is reconstructed from the emission measurement described above. However, the two gamma photons emitted at the point of annihilation may be absorbed within the patient before they reach the detector. Since the possibility for this absorption depends on the patient and on the line of response, it may be important to take the attenuation of the patient during the reconstruction of the emission image into account. In order to do this, it may be required to measure also transmission data of the patient and to reconstruct a so-called attenuation map. For this measurement, an additional x-ray source is placed inside the detector ring and the attenuation of the gamma photons by the human body is measured. Consequently, the patient is subjected to ionizing radiation: During the transmission measurement, and during the emission measurement. The transmission measurement can be performed before, after, or even simultaneous to the emission measurement.

As in CT scanners, where x-rays are employed, it is also a major concern in PET scanners to reduce or minimize a radiation to which a patient is subjected.

It is an object of the present invention to keep a radiation dose applied to an object during the transmission measurement of a PET scan low.

According to an exemplary embodiment of the present invention, the above object may be solved with a method of reconstructing image data from transmission data of a PET scan with the steps of measuring the transmission data by using a helical source trajectory, performing a parallel rebinning of the transmission data and reconstructing the image data from the rebinned transmission data.

The method according to this exemplary embodiment of the present invention takes all available data acquired during the PET scan into account and is thus very efficient in terms of dose utilization. Thus, it makes it possible to keep a dose to which an object is subjected very low.

According to an exemplary embodiment of the present invention as set forth in claim 2, a weighting of the rebinned transmission data is performed with the cosine of the cone angle and a row by row ramp filtering of the weighted rebinned transmission data is performed. According to this exemplary embodiment of the present invention, the correct cone-geometry is taken into account. Advantageously, this may lead to a superior image quality of the reconstructed image compared, for example, with single slice rebinning techniques.

According to an exemplary embodiment of the present invention as set forth in claim 3, a voxel dependent overscan weighting is performed such as for example an aperture weighting which allows for a proper normalization and thus for an improved image quality.

According to another exemplary embodiment of the present invention as set forth in claim 4, an image processing device for reconstructing image data from transmission data obtained from a PET scanner which measured the transmission data by using a helical source trajectory is provided, which allows for a very fast reconstruction of the image data with a reduced amount of calculation, since no further rebinning along the z-axis is employed. Further exemplary embodiments of the image processing device are provided in claims 4 and 5.

According to another exemplary embodiment of the present invention as set forth in claim 7, a PET system is provided using a helical source trajectory for measuring the transmission data of an object and which performs a parallel rebinning of the transmission data. Advantageously, this PET system allows for an improved image quality and for a reduced number of artifacts in the reconstructed image.

According to another exemplary embodiment of the present invention as set forth in claim 8, a computer program product is provided, comprising computer program means. The computer program product may be a data carrier such as a CD-Rom. However, the computer program product may also be a download from a network such as the WorldWideWeb, allowing to bring the computer program means from a server into a processor of a local image processor or computer.

It may be seen as the gist of an exemplary embodiment of the present invention that the transmission data scanned along a helical trajectory is parallel rebinned. Then, the data is weighted with the cosine of the cone-angle and ramp-filtered row by row. The filtered data are then back projected by using the rebinned geometry. During back projection, a voxel dependent overscan weighting may be performed.

These and other aspects of the present invention will become apparent from and elucidated with reference to the embodiments described hereinafter.

Exemplary embodiments of the present invention will be described in the following, with reference to the following drawings:

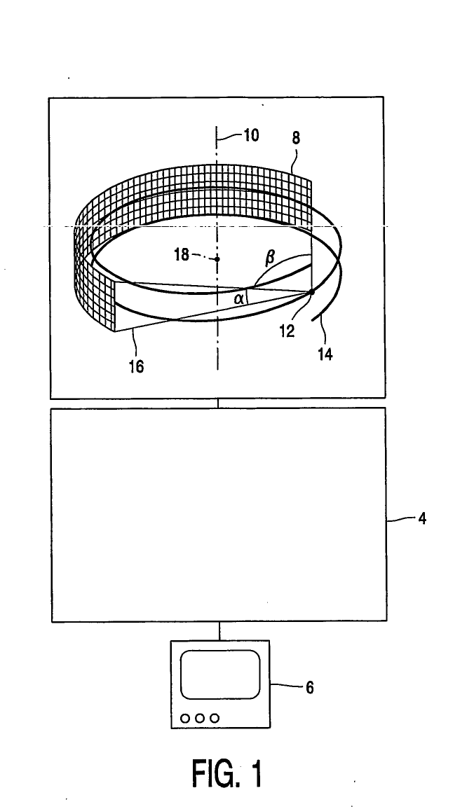

FIG. 1 shows an exemplary embodiment of a PET system (during transmission measurement) according to an exemplary embodiment including an image processing device according to an exemplary embodiment of the present invention.

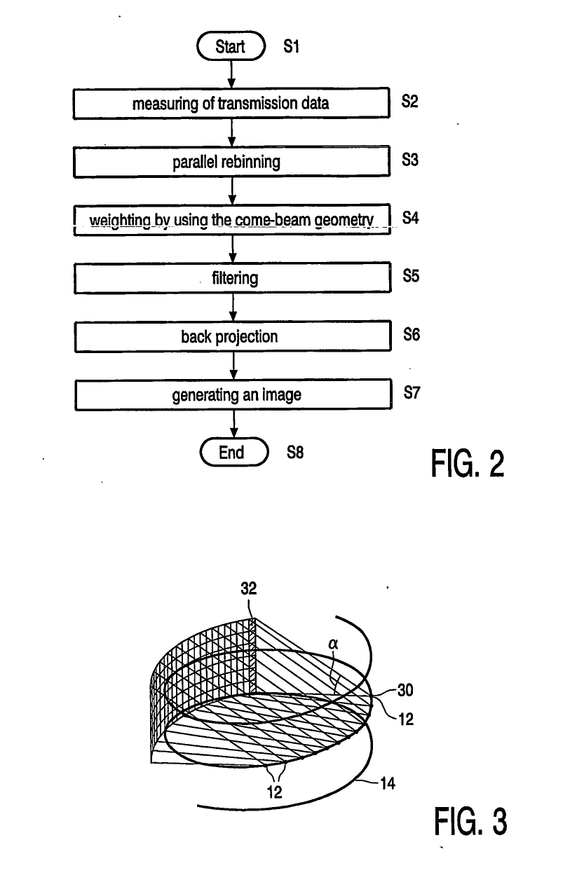

FIG. 2 shows a flow-chart of an exemplary embodiment of a method according to the present invention.

FIG. 3 shows a measurement geometry of the parallel rebinning according to an exemplary embodiment of the present invention.

FIG. 4 shows a coronal cross section of a thorax phantom obtained by advanced single slice rebinning.

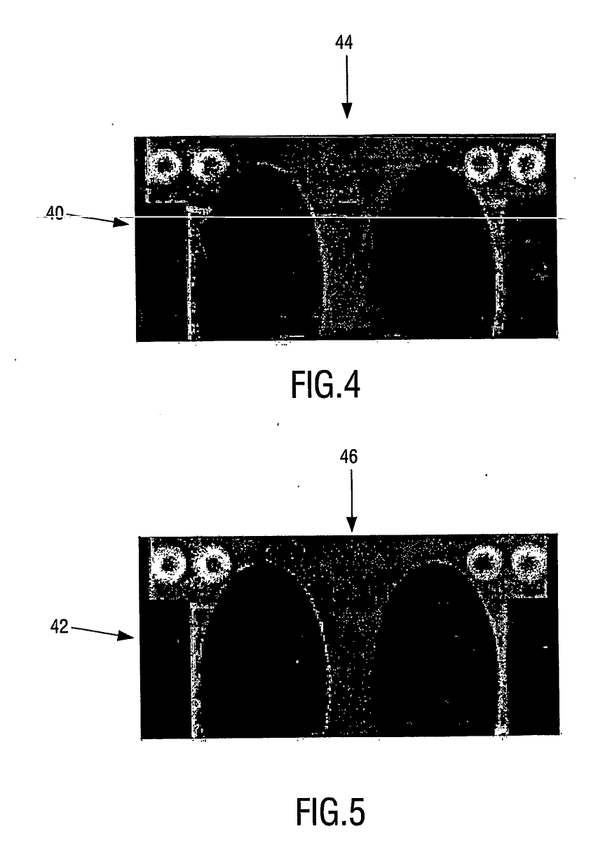

FIG. 5 shows a coronal cross section of a thorax phantom obtained with the method according to the present invention.

FIG. 1 shows a simplified schematic block diagram of a positron emission tomography (PET) scanner 2 including an image processing device 4 according to an exemplary embodiment of the present invention and a display 6. As may be taken from FIG. 1, the PET scanner according to the present invention comprises a fixed detector 8. The physical PET detector is a complete ring. However, during transmission measurement, only the part of the detector is used that is on the opposite side of the x-ray source. Only the used part of the detector is shown in the figure. The detector 8 consists of a plurality of detector element lines stacked to form a detector array. The detector 8 is fixedly arranged around the rotational axis 10 of the PET scanner 2. The arrangement of the detector 8 is such that each detector element of the detector 8 is arranged at the same fixed distance from the rotational axis 10. In other words, the curvature of the detector 8 is around the rotational axis 10.

Reference numeral 12 designates a source of radiation such as an x-ray source which may be a caesium compound in PET. The source of radiation 12 may be arranged, for example by means of suitable aperture systems not shown in FIG. 1 such that it emits a radiation beam 16. As may be taken from FIG. 1, the radiation beam 16 is a cone beam, having a cone beam angle α such that the radiation beam 16 covers a complete column of the detector 8. An opening angle β of the cone beam 16 is such that the cone beam 16 covers the complete desired field of view, which is related to the complete lines of the detector 8. According to an exemplary embodiment of the present invention, angles α and/or β of the beam of radiation 16 are adapted, for example by means of suitable aperture systems, such that all detector elements of the detector 8 are covered but no excess radiation impinges on adjacent areas of the detector 8. Due to the exact focus of the source of radiation 12 onto the detector 8, the PET scanner 2 according to this exemplary embodiment of the present invention allows to avoid unnecessary excess radiation applied to the object, i.e. the patient

Reference numeral 14 designates a helical source trajectory of the source of radiation 12 around the object of interest 18. The helical source trajectory 14 is achieved by rotation of the source of radiation 12 around the object of interest 18 and by displacing the object of interest 18 along or parallel to the rotational axis 10. The combination of the movement along the rotational axis 10 and the rotation of the source of radiation 12 around the object of interest 18 generates the helical source trajectory 14.

As mentioned above, during the scan, the object of interest 18 is translated along the rotational axis 10 and the source of radiation 12 is rotated around the object of interest 18 such that the helical source trajectory 14 is achieved. During a scan, the read-outs of the detector elements of the detector 8 are collected. These read-outs form transmission data of a PET scan. The transmission data is output to an image processing device 4 including, for example, a memory, a processor such as an image processor for reconstructing an image from the transmission data and for outputting an attenuation image on the basis of the image data via the display 6. Furthermore, the image processing device may be connected to a plurality of input/output devices, allowing an operator to control the operation of the PET scanner system 2.

The image processing device 4 is arranged for reconstructing image data from the transmission data obtained during a PET scan with a helical source trajectory. As mentioned above, the image processing device comprises a calculation unit such as an image processor, which is constructed to perform a parallel rebinning of the transmission data. Furthermore, the calculation unit 4 is constructed to reconstruct transmission image data for displaying an image on the display 6 from the rebinned transmission data.

As mentioned above, the calculation unit may be realized by means of a processor, including a working memory, including program means, which make the processor execute the parallel rebinning of the transmission data and the reconstruction of the transmission image data from the rebinned transmission data when the program means are executed on the processor. The program means may be provided to the processor by means of a computer program product such as a CD-Rom or may be downloaded from a network such as the WorldWideWeb.

FIG. 2 shows a simplified flow-chart of an exemplary embodiment for operating the PET system of FIG. 1 according to the present invention. After the start in step S1, the method continues to step S2, where the transmission data is measured using the helical source trajectory 14. A suitable transmission measurement geometry of a PET system is shown in FIG. 1 including the detector 8 and the source of radiation 12. After the acquisition of the transmission data in step S2, the method continues to step S2 where a parallel rebinning of the transmission data is performed. The measurement geometry achieved after the parallel rebinning in step S3 is shown in FIG. 3.

Reference numeral 14 in FIG. 3 designates the helical source trajectory. As may be taken from FIG. 3, a plurality of vertical fan-beam projections having a parallel orientation are arranged together to form the parallel rebinned measurement geometry. Each projection in FIG. 3 was taken at a different source position, i.e. the source of radiation 12 was on a different position of the helical source trajectory 14. In other words, the projections in FIG. 3 were taken at subsequent points of time during the scan.

The hatched column symbolizes one projection taken with a beam angle α at a source position 30 on the helical source trajectory 14.

Advantageously, according to an aspect of the present invention, no further rebinning along the z-axis, i.e. an axis parallel to the rotational axis 10 is performed, like for example in the WEDGE method as described in “3D image reconstruction for helical partial cone-beam scanners using wedge beam transform” by H. K. Tuy, U.S. Pat. No. 6,104,775 (Aug. 15^{th}, 2000).) which is hereby incorporated by reference.

After the parallel rebinning in step S3, the method continues to step S4, where a weighting of the parallel rebinned transmission data is performed by using the cone-beam geometry used during the scan of the transmission data. In step S4, the parallel rebinned transmission data are weighted with the cosine of the cone angle CL. In detail, the line integral, i.e. the integral of a line 32 (FIG. 3) of the array of parallel rebinned transmission data is multiplied with the cosine of the cone angle α. After the weighting in step S4, the method continues to step S5.

According to an exemplary embodiment of the present invention, a ramp-filtering of the parallel rebinned and weighted transmission data is performed. Preferably, the ramp-filtering is performed row by row. Then, the method continues to step S6, where a back-projection of the parallel rebinned and filtered transmission data is performed. According to an aspect of the present invention, the data after the filtering in step S5 is back-projected into the volume by using the rebinned geometry. According to an aspect of the present invention, the contribution of the rays which are parallel as seen along the rotational axis 10 to each object point, are weighted such that the total contribution is the same for every projection angle. In other words, during the back-projection, a voxel dependent overscan weighting such as for example an aperture weighting is performed to ensure a proper normalization. According to an aspect of the present invention, the same aperture weighting method can be applied as used in connection with the WEDGE method as described in “3D image reconstruction for helical partial cone-beam scanners using wedge beam transform” by H. K. Tuy, U.S. Pat. No. 6,104,775 (Aug. 15^{th}, 2000).) which is hereby incorporated by reference.

After the back-projection in step S6, the method continues to step S7, where the image processing device 4 generates an transmission image and outputs the image to the display 6, such that the image is displayed to an operator. Furthermore, the transmission image is passed to the emission image reconstruction unit, where it is used to reconstruct an emission image. Then, after step S7 the method continues to step S8, where it ends.

Advantageously, the method described with reference to FIG. 2 may take all available data into account and is thus very efficient in terms of dose utilization. In other words, due to the very high dose efficiency, a radiation dose applied to an object such as a patient can be controlled, so that an excess subjection to radiation is avoided. Furthermore, this method takes the cone-beam geometry into account, which leads to a superior image quality if compared, for example, to single slice rebinning techniques.

Furthermore, advantageously, in case there as inhomogeneities along the direction of the rotational axis 10, according to the present invention only little artifacts appear and thus a superior image quality can be provided. This will further be explained with reference to FIGS. 4 and 5.

FIG. 4 shows a cross-section of a thorax phantom obtained by an advanced single slice rebinning such as the one suggested by M. Kachelrieβ, S. Schaller and W. A. Kalender, “Advance single-slice rebinning in cone-beam spiral CT “Med. Phys., 27 (4):754-772, 2000.

FIG. 5 shows the same coronal cross-section of a thorax phantom obtained with the PET scanner depicted in FIG. 1 operated in accordance with the method depicted in FIG. 2. Arrow 40 in FIG. 4 points to a first image artifact in FIG. 4 and the arrow 42 points to the corresponding image artifact in the image of FIG. 5 obtained in accordance with the method depicted in FIG. 2. As may be taken from a comparison of these artifacts in FIGS. 4 and 5, the artifact in FIG. 5, i.e. the little white spot indicated by arrow 42 is much smaller than the white area indicated by arrow 40 in FIG. 4.

Furthermore, arrow 44 points to image artifacts in FIG. 4 being similar to horizontal polarization lines. A comparison of the same area indicated by arrow 46 in FIG. 5 shows that the lines indicated by arrow 46 are much less pronounced than in FIG. 4. Thus, according to the present invention, a better image quality is obtained, allowing for producing and generating images having a reduced number of image artifacts. Consequently, less artifacts will be generated in the emission image.

1. A method of reconstructing attenuation data from transmission data of a PET scan, the method comprising the steps of: measuring the transmission data by using a helical source trajectory, performing a parallel rebinning of the transmission data; and reconstructing the attenuation data from the rebinned transmission data.

2. The method of claim 1, wherein a cone-beam having a cone-angle angle is used for the measuring of the transmission data by using a helical source trajectory and wherein the reconstruction of the attenuation data from the rebinned transmission data comprises the steps of: weighting the rebinned transmission data with the cosine of the cone-angle; and performing a row-by-row ramp filtering of the weighted, rebinned transmission data.

3. The method of claim 3, wherein the weighted, rebinned transmission data are backprojected by using a geometry of the parallel rebinning and wherein, during backprojection, a voxel dependent overscan weighting is performed.

4. An image processing device for reconstructing attenuation data from transmission data obtained from a PET scanner which measured the transmission data by using a helical source trajectory, the image processing device comprising: a calculation unit; wherein the calculation unit is constructed to perform a parallel rebinning of the transmission data; and wherein the calculation unit is constructed to reconstruct the attenuation data from the rebinned transmission data.

5. The image processing device of claim 4, wherein a cone-beam having a cone-angle angle is used for the measuring of the transmission data by using a helical source trajectory and wherein calculation unit is constructed to weight the rebinned transmission data with the cosine of the cone-angle and to perform a row-by-row ramp filtering of the weighted, rebinned transmission data.

6. The image processing device of claim 5, wherein the weighted, rebinned transmission data are backprojected by means of the calculation unit by using a geometry of the parallel rebinning and wherein, during backprojection, a voxel dependent overscan weighting is performed.

7. A PET-system performing the steps of: measuring transmission data of an object by using a helical source trajectory; performing a parallel rebinning of the transmission data; and reconstructing attenuation data from the rebinned transmission data.

8. A computer program product comprising computer program means to execute the following steps when the computer program means are executed on an image processor: receiving transmission data acquired by means of a PET scanner by using a helical source trajectory; performing a parallel rebinning of the transmission data; and reconstructing the attenuation data from the rebinned transmission data.
